(19) United States
(12) Patent Application Publication
(10) Pub. No.: US 2010/0294719 A1
(43) Pub. Date: Nov. 25, 2010

(54) PROCESS FOR TREATMENT OF PRODUCED WATER

(76) Inventors: David M. Polizzotti, Yardley, PA (US); Graham Sim, Melbourne (AU)

Correspondence Address: General Electric Company;GE Global Patent Operation, 2 Corporate Drive, Suite 648, Shelton, CT, 06484, US

(21) Appl. No.: 12/468,095

(22) Filed: May 19, 2009

(51) Int. Cl. C02F 1/44

(52) U.S. Cl. 210/654; 210/184

(57) ABSTRACT

A process for treating produced water in heavy oil production comprises, providing an oil/water mixture gathered from an oil/water collection well, whereby oil from said oil/water mixture is separated to provide an oil product and a produced water product containing oil, dissolved gases and dissolved solutes. Said produced water product is then deoiled, and the deoiled water subsequently passes though a membrane system, resulting in permeate water and reject. The resulting permeate water is sent on to a boiler system for production of steam, and the reject is introduced into an evaporator to result in distillate water and blow down. Thereafter, the blow down may be charged into zero liquid discharge treatment; and the distillate water added to the membrane permeate.

### FIELD OF THE INVENTION

This invention relates to a process for pre-concentrating produced water, particularly the water that is produced during bitumen recovery in tar or oil sands.

### BACKGROUND OF THE INVENTION

In certain geologic formations, such as those referred to as oil sands, or tar sands, steam is used to recover the heavy oil in these formations. Steam is injected into the heavy oil bearing formations, it heats the heavy oil, or bitumen, making it more viscous, and allowing for the oil and water mixture to be collected and pumped to the surface. Steam that condenses into water and mixes with the oil, and then subsequently separated from the oil, is called produced water. In new wells, the water to oil ratio is in the vicinity of 3:1. As wells age, the water to oil ratio changes, and can go as high as 7:1. In some cases, the oil and produced water are separated, the produced water is recycled for reuse to make steam for reinjection into the well formation.

Treating the produced water to the required standard for steam generation can be challenging. In a known process, the produced water can be subjected to various processes for forming distillate for steam generation. For example, the water produced as a consequence of bitumen recovery is separated from the oil by so called “free water knock out” and “treater” devices. The water is then further cleaned by processing via skim tanks, flotation (usually induced gas flotation) and then on to oil recovery filtration (usually walnut shell filters) apparatus. Any oil recovered from skim tanks, flotation, or other processing steps is collected for upgrading. The resulting oil free water from the de-oiling operation continues on for processing into steam, most commonly via evaporation. In the case where an evaporator is used, distillate reports to the boiler for steam generation, and said steam is then directed back down into the oil sands formation. Blowdown from the evaporator may report to a crystallizer in cases where zero liquid discharge is required. Water from the crystallization process may be added to the evaporator distillate reporting to the boiler.

As shown in FIG. 1, which depicts a typical prior art produced water treatment process 100, the oil/water mixture that is collected proceeds to a free water knock out step 105, and then on to a treater 110. From there, the water and oil are separated, and the oil is sent to a diluent tank 115. After the diluent tank 115, the oil continues on to an upgrader 120.

The produced water which comes out of the treater 110, is sent on to a skim tank 125, for again separating the oil and water. From the skim tank 125, the water is sent to induced gas filtration 130 and then to oil recovery filtration, such as a walnut shell filtration (WSF)135. Any oil collected from these steps is sent to the upgrader 120. The water from the WSF 135 is introduced to an evaporator 140, which sends any distillate water on to the boiler, for steam generation and its reject off to suitable discharge 150 treatment.

Typical processes may treat the water produced from the deoiling operation prior such as by evaporation as noted above or by softening or other means, such as ion exchange, to prepare it for use as boiler feed water. It is understood that the water/oil mixture that is pumped from the well is at elevated temperatures through the deoiling process, typically in the range of from about 85 to 95° C. Since the water is hot, and because it has been in contact with naturally occurring silicate mineral in the ground formation, or well, the produced water is saturated with silica. Silica is problematic in that its concentration must be controlled when the water is used to make steam, such as in the boiler. Water that is saturated with silica can cause fouling on heat transfer surfaces, especially in evaporators and crystallizers. Furthermore, it is clear that any method that would concentrate produced water, would suffer from and have to address the matter of silica related depositions.

In cases where an evaporator is used to receive deoiled water, the evaporator produces a distillate that reports to a boiler for steam generation. This steam is directed back down into the oil sands formation or well to recover additional oil Blowdown from the evaporator may report to a crystallizer in such cases where zero liquid discharge is required. Water from the crystallization process is added to the evaporator distillate reporting to the drum boiler. This process of preparing the deoiled produced water for use as boiler feed by an evaporation process is highly energy intensive. It is not unusual for the energy required to evaporate water using a vapor compression evaporator to be in the vicinity of 50 kWhr/1000 gallons.

An alternate solution that is currently used is to pretreat the deoiled produced water by softening. In the case of softening, the technology is well known and widely practiced. For example, it is common practice to raise the pH of the produce water to greater than 10, and to add lime or magnesium oxide to precipitate silica as magnesium silicate. In this way, other metal hydroxides and problematic cations in the influent water are removed. In such a case, the resulting sludge may be settled in clarifiers and removed. Overflow from the clarification process is pH adjusted, filtered and further processed via polishing for subsequent use as boiler feed water.

Because softening is manpower intensive is problematic, requires chemicals and a means of sludge disposal, softening is being replaced by evaporation on a somewhat rapid basis. In cases where softening is still used, a need remains for a trouble free and robust deoiling solution to prevent the coating of softening sludge with oils that shut down the softening reactions.

In practice the operations described above for deoiling are often not capable of dealing with process upsets. Hence, bitumen and other impurities are allowed to carry over into the downstream process where their presence interferes with the production of clean water for steam generation.

Accordingly, there is a need to improve the deoiling operation by improving its robustness especially with regards to process upsets.

### SUMMARY OF THE INVENTION

A process has been found to deoil water which provides a more efficient and cost effective method than has heretofore been possible. The improved deoiling process enables the utilization of a membrane system in the downstream process, prior to an evaporation step. The use of membranes in the process enables a 75% reduction in the amount of produced water that needs to pass through an evaporator. Such a reduction allows for a much smaller capacity evaporator, thereby resulting in significant cost and energy savings across the process.

According to one embodiment, a process for treating produced water in heavy oil production comprises, providing an oil/water mixture gathered from an oil/water collection well, whereby oil from said oil/water mixture is separated to provide an oil product and a produced water product containing oil, sand and dissolved solutes. Said produced water product is then deoiled, and the deoiled water subsequently passes though a membrane system, resulting in permeate and reject water. The resulting permeate water is sent on to a boiler system for production of steam, and the reject may be introduced into an evaporator wherein its distillate water reports to the steam boiler and its and blow down water is disposed of.

In a further alternative embodiment of the invention, additional steps are added to the process, including energy recovery, and a means of removing silica.

The various features of novelty which characterize the invention are pointed out with particularity in the claims annexed to and forming a part of this disclosure. For a better understanding of the invention, its operating advantages and benefits obtained by its uses, reference is made to the accompanying drawings and descriptive matter. The accompanying drawings are intended to show examples of the many forms of the invention. The drawings are not intended as showing the limits of all of the ways the invention can be made and used. Changes to and substitutions of the various components of the invention can of course be made. The invention resides as well in sub-combinations and sub-systems of the elements described, and in methods of using them.

### BRIEF DESCRIPTION OF THE DRAWINGS

FIG. 1 is a schematic of a typical prior art process;

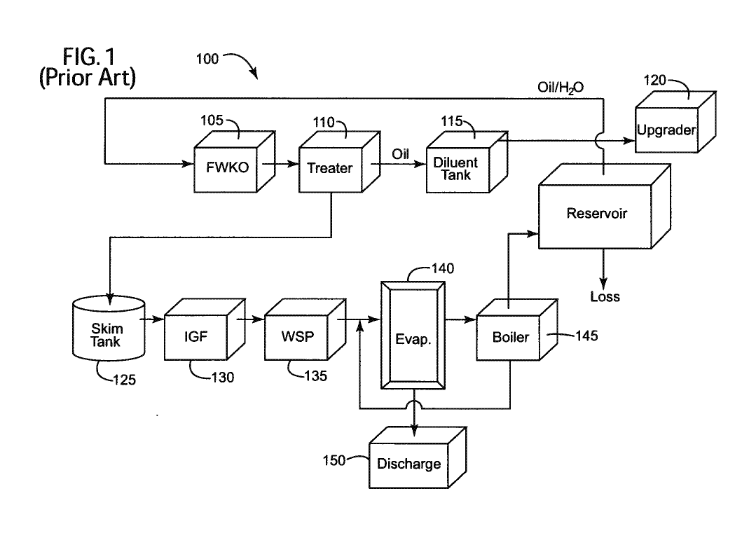

FIG. 2 is a schematic of one embodiment of the process according to the present invention.

### DETAILED DESCRIPTION OF THE INVENTION

The singular forms “a,” “an” and “the” include plural referents unless the context clearly dictates otherwise.

The modifier “about” used in connection with a quantity is inclusive of the stated value and has the meaning dictated by the context (e.g., includes the degree of error associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

A process is disclosed for treating produced water in heavy oil production that comprises, providing an oil/water mixture gathered from an oil/water collection well, whereby oil from said oil/water mixture is separated to provide an oil product and a produced water product containing oil, sand and dissolved solutes. Said produced water product is then deoiled, and the deoiled water is subsequently made to pass though a membrane system, resulting in permeate water and reject. The resulting permeate water is sent on to a boiler system for production of steam, and the reject is introduced into an evaporator resulting in distillate water and blow down. Thereafter, the blow down may be charged into zero liquid discharge treatment; and the distillate water added to the membrane permeate.

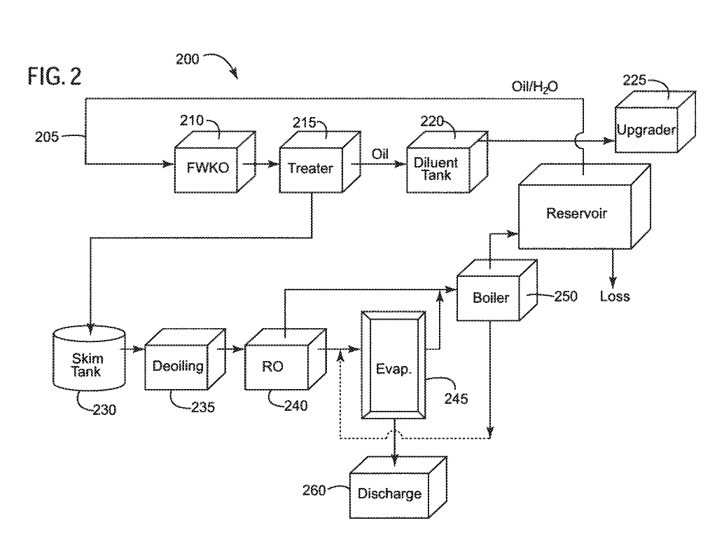

Depicted in FIG. 2 is a schematic of a process for treating produced water in heavy oil production 200. An oil/water mixture gathered from an oil/water collection well, whereby oil from said oil/water mixture 205 coming from the well, is processed through a free water knock out step 210 and then sent on to a treater 215. The oil from the treater 215, is sent on to a diluent tank 220 and then on to the upgrader 225. The produced water from the treater 215, is sent to a skim tank 230 to be separated to provide an oil product and a produced water product containing oil, dissolved gases and dissolved solutes. Said produced water product is then deoiled 235, and the deoiled water subsequently passes though a membrane system 240, resulting in permeate water and reject. The resulting permeate water is sent on to a 250 boiler system for production of steam, and the reject is introduced into an evaporator 245 to result in distillate water and blow down. Thereafter, the blow down may be charged into zero liquid discharge treatment 260; and the distillate water added to the membrane permeate.

With respect to deoiling 235, the process may be comprised of one or a number of combinations of various means to render the produced water free of oil. The deoiling process may comprise chemical and/or mechanical means, or combinations thereof. For chemical processing the process may comprise the use of emulsion breakers, reverse breakers, sorbents, specialty chemicals or combinations thereof. Emulsion breakers are designed to remove oil from a water continuous phase, while reverse breakers are designed to remove oil from a water continuous matrix. The inclusion of sorbents is to remove both submicron oil and/or emulsified oils from the water. An alternate embodiment allows for the use specialty chemicals to enhance the oil/water separation. Such specialty chemicals may be added prior to or directly to a flotation step in the process.

An alternate embodiment for the deoiling step is the use of mechanical means such as membranes or other separator devices. In the case of membranes, ceramic or polymeric membranes may be used, and if the latter, the polymeric membranes may be micofilters, ultrafilters, nanofilters, or any combinations thereof. In an embodiment that includes the use of polymeric membranes, new membrane materials and/or housing components may be required to render them stable to the high temperatures normally found in the deoiling process. Recall that the produced water is at elevated temperatures through the deoiling process, typically in the range of from about 90 to 95° C.

An alternate embodiment of the present process provides for the inclusion of an alternate mechanical means for deoiling, such as a cyclonic or other method. One such device representative of the concept is Voraxial separator. An additional alternative is the use of chemicals to improve the efficiency of any such separation device.

Subsequent to the deoiling step, an embodiment provides for the produced water to be treated by a membrane. In particular, it is seen that there are advantages to reverse osmosis (RO) membranes, specifically high temperature reverse osmosis membranes. However, it is noted that these are not the only membranes that can be used in this step. The use of membranes at this point of the process is novel, and provides a means for reducing energy consumption and overall process cost. The membrane system itself will allow reduction of the energy requirement used for produced water processing from about 50 kWh/m³, down to from about 3 to about 6 kWh/m³. Additionally, use of high temperature RO membranes allows for high temperature tolerance. Permeate water collected from a membrane system would report to a boiler system for production of steam. Reject from the membrane system would report to an evaporator. An additional advantage from this embodiment of the process is that approximately 75% of the deoiled water would be sufficiently processed by the membrane, such that it would go directly to the boiler system. This then leaves about 25% of the deoiled water volume that still needs processing, via an evaporator, but thereby requiring a much smaller sized evaporator than would otherwise be used in current systems.

The evaporator provides distillate water that may be added to the RO permeate to go to the boiler system, and blow down that could report for zero liquid discharge treatment. A further embodiment would provide for the addition or inclusion of an energy/heat recovery device or devices, such as but not limited to a high efficiency heat exchanger, prior to the membrane system to allow a broader range of membranes to be used effectively.

A further embodiment of the present process provides for the remediation or removal of silica prior to the RO membrane system. As previously discussed, there are multiple methods and schemes proposed and in use for the remediation of silica. One common method, noted above, is to soften the water using classical lime/magnesium oxide softening technology. However, as previously stated, this method is often problematic and is not a preferred means. Other methods including ion exchange with pH manipulation and degassing are known and may be practiced in various forms. In such methods, it is important to remove all hardness ions and to elevate the pH greater than 10, so as to solubilize the silica to prevent deposit formation and fouling in subsequent processes that will concentrate the feed water. Other known methods include the use of activated alumina. The use of activated alumina to remediate silica is particularly attractive due the conditions under which the present process operates. As previously stated, the water/oil mixture that is pumped from the well is at elevated temperatures through the deoiling process, typically in the range of from about 90 to 95 ° C. Additionally, activated alumina is particularly attractive in this application of produced water as it is easily regenerated with caustic. One embodiment would provide that the stream containing regenerated silica would report to a crystallizer and be concentrated to a solid waste product, such as in the case of zero water discharge. In alternate embodiments, it is possible for the stream containing regenerated silica to report to a clarifier receiving evaporator concentrate for subsequent precipitation of magnesium silicates via well known and commonly used methods of magnesium oxide softening. This is especially of value if the operation calls for deep well injection. In either case, the need to dispose of spent waste as in the case of classical softening is minimized. Furthermore, there is no need for costly pH manipulation of the entire water flow process, and in situations that incorporate or include ion exchange, there would be no requirement for regeneration of multiple ion exchange columns with subsequent disposal of water materials. In fact, the silicate containing waste stream may have value as a sellable by-product to glass manufacurers and others seeking an inexpensive source of raw sodium silicate.

Activated alumina may be used in all of the forms in which it is available, including but not limited to nanosized alumina. An advantage of the nanosized alumina, or other nanosized sorbant is to increase the surface area of the sorbant, which is important in attaining high silca removal. Additionally, the alumina may be used on its own, or may be affixed to a support. Fixing nanosized alumina or other sorbents, such as but not limited to magnesium oxide to a support, such as a resin bead, is included in the scope of the invention.

While the present invention has been described with references to preferred embodiments, various changes or substitutions may be made on these embodiments by those ordinarily skilled in the art pertinent to the present invention with out departing from the technical scope of the present invention. Therefore, the technical scope of the present invention encompasses not only those embodiments described above, but all that fall within the scope of the appended claims.

What is claimed is:

1. A process for treating produced water in heavy oil production, comprising:
a) providing an oil/water mixture gathered from an oil/water collection well;
b) separating oil from said oil/water mixture to provide an oil product and a produced water product containing oil, dissolved gases and dissolved solutes:
c) de-oiling said produced water product;
d) passing the de-oiled produced water product though a membrane system, resulting in permeate water and reject;
e) sending the permeate water to a boiler system for production of steam;
f) introducing the reject into an evaporator to result in distillate water and blow down;
g) discharging the blow down into zero liquid discharge treatment; and
h) adding the distillate water to the membrane permeate.

2. The process of claim 1, wherein the deoiling comprises chemical means, mechanical means or combinations thereof.

3. The process of claim 2 wherein the chemical means comprises emulsion breakers, reverse breakers, sorbants, specialty chemicals, or combinations thereof.

4. The process of claim 2 wherein the mechanical means comprises membranes.

5. The process of claim 2 wherein the mechanical means comprises ceramic membranes, polymeric membranes, or combinations thereof.

6. The process of claim 2 wherein the mechanical means comprises polymeric membranes chosen from the group consisting of micofilter membranes, ultrafilter membranes, nanofilter membranes, or combinations thereof.

7. The process of claim 2 wherein the mechanical means comprises a voraxial.

8. The process of claim 1 which further comprises an energy and/or heat recovery device prior to the deoiling process of step c.

9. The process of claim 1 wherein the membrane of step d is a reverse osmosis membrane.

10. The process of claim 1 wherein the membrane of step d is a high temperature reverse osmosis membrane.

11. The process of claim 1 wherein the reject from step f is less than or equal to 25% of the de-oiled produced water volume of step d.

12. The process of claim 1 which further comprises an energy and/or heat recovery device prior to the membrane system of step d.

13. A system for treating produced water in heavy oil production, comprising a membrane wherein the membrane is situated subsequent to the deoiling step.
